(19) United States
(12) Patent Application Publication
(10) Pub. No.: US 2026/0290953 A2
(43) Pub. Date: Sep. 24, 2026

(54) Battery Cell Housing Made of an Aluminium Alloy Strip with Improved Weldability and High Level of Recycled Content

(71) Applicant: Martin Christoph Lentz, Bonn (DE)

(72) Inventor: Martin Christoph Lentz, Bonn (DE)

(73) Assignee: Speira GmbH, Grevenbroich (DE)

(21) Appl. No.: 19/338,706

(22) Filed: Sep. 24, 2025

Related U.S. Application Data
(63) Continuation of application No. PCT/EP2024/059051, filed on Apr. 3, 2024.

(30) Foreign Application Priority Data
Apr. 4, 2023 (EP) 23166597.7

(51) Int. Cl. H01M 50/131; H01M 50/119; H01M 50/159; H01M 50/169

(52) U.S. Cl. CPC H01M 50/131; H01M 50/119; H01M 50/159; H01M 50/169

(57) ABSTRACT

The invention relates to a battery cell housing having an aluminium alloy strip or sheet and to a use of an aluminium alloy strip or sheet for manufacturing a battery cell housing. The object of specifying a battery cell housing having an aluminium alloy strip or sheet that enables high recycling rates to be achieved, meets the requirements for a battery cell housing, in particular with regard to strength, electrolyte resistance and electrical and thermal conductivity, and can additionally provide a sufficiently large process window for welding processes for the manufacture of welding defect-free battery cell housings is achieved with a battery cell housing and by using an aluminium alloy strip or sheet for manufacturing a battery cell housing.

### CROSS-REFERENCE TO RELATED PATENT APPLICATIONS

This patent application is a continuation of International Application No. PCT/EP2024/059051, filed on Apr. 3, 2024, which claims the benefit of priority to European Patent Application No. 23166597.7, filed Apr. 4, 2023, the entire teachings and disclosures of both applications are incorporated herein by reference thereto.

### FIELD OF THE INVENTION

The invention relates to a battery cell housing having an aluminium alloy strip or sheet and to a use of an aluminium alloy strip or sheet for manufacturing a battery cell housing.

### BACKGROUND OF THE INVENTION

Battery cells are used in a wide variety of technical applications to supply an electrical load with electrical energy. Application fields for battery cells are, for example, in electromobility, particularly in electric cars, electric bicycles and electric scooters, in consumer electronics, particularly in laptop computers, tablet computers, mobile phones, digital cameras and video cameras, or in energy technology, particularly in battery storage, to name just a few. A plurality of battery cells are often connected together in series or parallel to form a battery module, or a battery system. However, there are also applications in which individual battery cells are used as an energy source.

Battery cells may essentially be differentiated into primary cells, which can only be discharged once and cannot be recharged, and secondary cells, which are rechargeable. The necessary electrochemical processes that provide the functionality of the battery cell may be implemented with a wide variety of different materials in both primary and secondary cells. Examples of primary cells in this context are alkali-manganese cells, zinc-carbon cells, nickel oxyhydroxide cells or lithium/iron sulphide cells, to name just a few. Examples of secondary cells are lithium ion cells, sodium ion cells, nickel-cadmium cells, nickel/metal hydride cells or nickel-zinc cells, to name just a few.

For a number of years, lithium ion secondary cells have increasingly been used particularly in the fields of electromobility and consumer electronics, among other things because of their comparatively high gravimetric and volumetric energy densities. Like other types of battery cells, lithium-ion secondary cells have a battery cell housing. This forms the outer shape of the battery cell and encloses a cavity, which contains among other things the anode material, the cathode material and an electrolyte. A distinction may be made between various designs of a battery cell housing: cylindrical battery cell housings essentially have the shape of a cylinder. If the height of the cylinder is greater than the diameter, they are referred to as round cells, otherwise as button cells. Battery cell housings of prismatic design essentially have the shape of a prism, in particular a cuboid. Another variant is the pouch design, in which the battery cell housing essentially has the shape of a pocket or pouch.

Owing to high requirements for strength and mechanical stability as well as high requirements for electrochemical stability in relation to the electrolyte acting corrosively on the battery cell housing, cylindrical battery cell housings in particular have to date generally been manufactured from nickel-plated steel. Increasingly large cell formats, however, such as the growing replacement of round cells of type 18650 with round cells of type 21700 and the expected future replacement of round cells of type 21700 with round cells of type 4680 or other larger formats in the field of electromobility, are placing higher requirements on the electrical and thermal conductivity since larger amounts of heat, which need to be dissipated, are generated. Potential aluminium materials must furthermore fulfil the high requirements for the strength of the housing material.

Approaches with the use of aluminium alloys for cylindrical battery cell housings are already known, but are limited to the aluminium alloy AA3003. The United States patent U.S. Pat. No. 6,258,480 B1 may be mentioned as an example of this. For prismatic battery cell housings, on the other hand, the aluminium alloy AA3003 is standard, although use in the field of prismatic cell housings is also limited to this alloy.

The United States patent US 2006/093908 A1 discloses a high-strength battery housing which consists of a composite material having an outer plastic layer and an aluminium foil made of an aluminium alloy of type AA8079, 1N30, AA8021, AA3003, AA3004, AA3104 or AA3105.

The same aluminium alloys are known from the Korean patent application KR 2016 005673 A, although the Korean patent application prefers the use of an aluminium alloy of type AA3003.

The Japanese patent application JP 2015 125886 A focuses on the strength and weldability of the battery housings and proposes the use of aluminium alloys of type AA3003, AA3203, AA3004, AA3104, AA3005 or AA3105.

However, none of the aforementioned documents addresses the problem of the use of recycled material, taking into account the further requirements for the strength, electrolyte stability and electrical and thermal conductivity of the battery cell housing and the weldability of the materials used.

The greatly increased sustainability requirements in recent years are requiring the production of battery cell housings with the smallest possible resource use and CO₂ footprint. The most effective way is to reduce the use of energy-intensive primary aluminium by the increased use of recycled material, also referred to as secondary aluminium. This is obtained by melting aluminium scrap. In the case of aluminium scrap, a distinction is made between pre-consumer scrap and post-consumer scrap. Pre-consumer scrap is waste which is generated during the manufacture of semi-finished products or end products made from aluminium or aluminium alloys in a wide variety of possible processes. Pre-consumer scrap may be further divided into internal process scrap on the one hand, which is unavoidably generated within the process of manufacturing aluminium strips or sheets, such as sprues, offcuts, swarf, production residues or production rejects, and external process scrap on the other hand, which is unavoidably generated in the further processing to form the end product, such as punching scrap, swarf or production rejects. Post-consumer scrap is an end product which has fully completed its life cycle and becomes waste after it has been used. It is irrelevant whether or not it was used by an end user, which means that it may also have been used in an industrial or commercial facility, for example. Examples of post-consumer scrap include food packaging, in particular beverage cans, window frames, lithographic printing plate carriers, cable cores and automotive components.

According to the international specification, the alloy composition of the aluminium alloy AA3003 hitherto used for battery cell housings is comparatively restrictive, for example with regard to the standard alloy elements copper, magnesium, chromium, zinc and titanium. Employing this alloy therefore requires the use of high proportions of primary aluminium and thus hinders the achievement of high recycling rates with decreased energy use. Battery cell housings of the prior art made from the aluminium alloy AA3003 therefore need to be improved with regard to their sustainability.

At the same time, welding has emerged as a very important joining technique for the manufacture of battery cell housings, as it is economically viable, and welded connections can meet high impermeability and strength requirements. Laser welding is particularly important here, which is generally carried out without the use of welding consumables.

However, problems arise when welding metals and aluminium alloys in particular, and these problems must be assessed critically with regard to the manufacture of battery cell housings. The tendency to hot crack and the formation of welding pores which impair the impermeability of the battery cell housing represent faults in the welding process which can render the battery cell housing unusable, i.e. lead to scrap during the manufacture of battery cell housings.

Hot cracks are cracks in the welded material that can occur immediately after welding due to the shrinkage process of the cooling material when the stresses that occur during the shrinkage process can no longer be absorbed by the welded material. The result can be a significant loss of strength of the welded connection, which can lead to premature failure of the battery housings. In addition, gas impermeability can no longer be sufficiently guaranteed in the event of hot cracking.

The formation of welding pores, on the other hand, primarily impairs the impermeability of the welded connections of the battery cell housings with regard to the escape of gases. Both problems can be avoided by selectively using process parameters. However, if the possible process window becomes too small, the percentage of rejects can increase, as certain parameter fluctuations are always present in the welding process. Since the seal welding of the cell housing body and the lid generally takes place at a late stage of the manufacturing process at which a significant part of the value creation has already taken place through the use of expensive chemicals and processes, increased scrap rates can usually not be tolerated.

### SUMMARY OF THE INVENTION

Against this background, the present invention is based on the object of specifying a battery cell housing having an aluminium alloy strip or sheet which enables the realisation of high recycling rates, is sufficient to meet the requirements for a battery cell housing, in particular with regard to strength, electrolyte resistance and electrical and thermal conductivity and can also provide a sufficiently large process window for welding processes to produce welding defect-free battery cell housings. A further object of the present invention is to provide a corresponding use of an aluminium alloy strip or sheet for manufacturing a battery cell housing.

According to a first teaching of the present invention, the aforementioned object is achieved for a battery cell housing having an aluminium alloy strip or sheet in that the aluminium alloy strip or sheet has an aluminium alloy with the following alloy constituents in wt %:

$$0.1 \% \leq Si \leq 0.7 \% , \\ 0.2 \% \leq Fe \leq 0.8 \% , \\ Cu \leq 0.6 \% , \\ 0.3 \% \leq Mn \leq 1.5 \% , \\ 0.01 \% \leq Mn \leq 0.6 \% , preferably 0.05 \% \leq Mn \leq 0.55 \% , \\ Cr \leq 0.25 \% , \\ Zn \leq 0.5 \% , \\ Ti \leq 0.2 \% ,$$

the remainder being Al and unavoidable impurities, individually at most 0.05% and in total at most 0.15%.

It has been shown that high proportions of recycled contents can lead to increased Si contents in the aluminium alloy. However, in combination with high Mg contents, the tendency of the aluminium alloy to hot crack then increases significantly during welding. This significantly reduces the process window when welding processes are used to manufacture battery cell housings, so hot cracks can occur after welding. The same applies to the occurrence of welding pores, the formation of which is promoted with increasing Mg content due to the low vapour pressure of Mg. However, the battery cell housing according to the invention having an aluminium alloy strip or sheet with the above-mentioned composition allows the use of very high proportions of recycled contents in the manufacture of the aluminium alloy strips. At the same time, higher strengths, in particular higher yield strengths R_{p0.2}, are provided compared to a known AA3003 alloy composition, whereby lower wall thicknesses of the battery cell housing can be achieved compared to the known AA3003 alloy. Due to the combination of the Si, Fe, Cu and Mg contents according to the invention, the battery cell housing according to the invention is well suited to the realisation of high proportions of recycled contents. This applies in particular to the use of aluminium packaging scrap and UBC scrap (UBC: used beverage can), i.e. beverage cans made of aluminium alloys, which have significant contents of magnesium and copper and are suitable for manufacturing the aluminium alloy of the aluminium strip or sheet of the battery cell housing. At the same time, a wide process window is provided for welding processes, as the tendency to hot crack and to form welding pores is reduced by the alloy composition.

All of the above-mentioned advantages are achieved by the alloy composition of the aluminium alloy strip or sheet of the battery cell housing. Since the aluminium alloy furthermore contains only standard alloy elements, it can itself also be recycled well, so that the battery cell housing according to the invention may readily be added to existing scrap recycling operations. In addition, due to the alloy composition, the electrolyte resistance compared to the already known alloy AA3003 is not deteriorated or not significantly deteriorated, so economically and sustainably manufacturable battery cell housings can be provided.

According to the invention, the silicon content of the aluminium alloy is in the range 0.1 wt %≤Si≤0.7 wt %, thus enabling particularly high recycling rates. In one embodiment of the battery cell housing according to the invention, the silicon content of the aluminium alloy is in the range 0.2 wt %≤Si≤0.55 wt %, preferably 0.35 wt %≤Si≤0.55 wt %, particularly preferably 0.40% wt≤Si≤0.50 wt %. In combination with the iron and manganese contents according to the invention in the amounts specified, the silicon content of 0.1 wt %≤Si≤0.7 wt % leads in particular to relatively uniformly distributed, compact particles of the quaternary α-Al(Fe,Mn) Si phase. These precipitated particles increase both the strength of the aluminium alloy and its electrical and thermal conductivity, since they remove iron and manganese from the solid solution without detrimentally affecting other properties such as corrosion behaviour, i.e. the electrolyte stability, or formability. Silicon contents of less than 0.1 wt % lead to reduced precipitation of α-Al(Fe,Mn) Si phases, which may impair the electrical and thermal conductivity because of dissolved manganese. Furthermore, the absence of α-Al(Fe,Mn) Si phases has a detrimental effect on the tool wear. Silicon contents of more than 0.7 wt % may lead, in combination with magnesium, to the increased formation of Mg₂Si phases, which detrimentally affects the solid solution hardening of magnesium. The silicon content of the preferred embodiment of 0.2 wt %≤Si≤0.55 wt %, preferably 0.35 wt %≤Si≤0.55 wt % and 0.40 wt %≤Si≤0.50 wt % represents an ideal compromise between high strength and high electrical and thermal conductivity while providing wide process windows for welding.

According to the invention, the iron content of the aluminium alloy is in the range 0.2 wt %≤Fe≤0.8 wt %. In one embodiment of the battery cell housing according to the invention, the iron content of the aluminium alloy is in the range 0.2 wt %≤Fe≤0.65 wt %, preferably 0.25 wt %≤Fe≤0.55 wt %. The iron content of 0.2 wt %≤Fe≤0.8 wt % in combination with the manganese content according to the invention in the amount specified leads to the formation of Al₆(Mn,Fe) phases, and, as already explained above, in combination with the silicon and manganese contents according to the invention in the amounts specified to the precipitation of particles of the quaternary α-Al(Fe,Mn) Si phase. Iron in this case contributes to lowering the solubility of manganese in aluminium, so that more manganese is bound in intermetallic phases, which has a positive effect on the electrical and thermal conductivity. Moreover, the intermetallic phases influence recovery and recrystallisation processes and improve the thermal stability of the mechanical properties. Iron contents of more than 0.8 wt % promote the formation of coarse intermetallic phases, which may impair the formability in the deep drawing process. Iron contents of less than 0.2 wt %, on the other hand, limit the tolerance of the aluminium alloy for ferrous scrap too greatly since conventional scrap grades generally have a significant proportion of iron. Limiting the iron content too greatly may therefore hinder the achievement of high recycling rates. The corridor of the iron content of said embodiment of 0.2 wt %≤Fe≤0.65%, preferably preferably 0.25 wt %≤Fe≤0.55 wt %, therefore represents an ideal combination of recyclability, use of high proportions of recycled material, thermal stability, electrical and thermal conductivity and formability.

According to the invention, the copper content of the aluminium alloy is in the range Cu≤0.6 wt %. In one embodiment of the battery cell housing according to the invention, the copper content of the aluminium alloy is in the range 0.3 wt %≤Cu, preferably 0.1 wt %≤Cu≤0.2 wt %, particularly preferably 0.10% wt≤Cu≤0.20 wt %. The fact that a copper content of up to 0.6 wt % is permitted results in an increased tolerance of the aluminium alloy for copper-containing aluminium alloy scrap, which promotes the achievement of high proportions of recycled material in the manufacture of the battery housing. However, since excessively high copper contents may have a detrimental effect on the corrosion properties, the copper content is limited according to the invention to at most 0.6 wt % in order to achieve a sufficiently high electrolyte stability. For improved electrolyte stability and sufficiently high electrical and thermal conductivity, the copper content in the aforementioned embodiment is limited to 0.3 wt %. However, the presence of copper also causes an increase in the strength of the aluminium alloy by solid solution hardening, although this only becomes significant above a content of 0.1 wt %. A preferred range of 0.1 wt %≤Cu≤0.2 wt % or 0.10 wt %≤Cu 0.20 wt % therefore represents a compromise between high strength, sufficiently high electrical and thermal conductivity and further improved electrolyte stability with sufficient recycling tolerance.

According to the invention, the manganese content of the aluminium alloy is in the range 0.3 wt %≤Mn≤1.5 wt %. In one embodiment of the battery cell housing according to the invention, the manganese content of the aluminium alloy is in the range 0.3 wt %≤Mn≤1.4 wt %. As already explained above, the manganese content of 0.4 wt %≤Mn≤1.3 wt %, preferably 0.6 wt %≤Mn≤1.1 wt %, leads in combination with the silicon and iron contents in the amounts specified to the precipitation of particles of the quaternary α-Al(Fe,Mn) Si phase as well as the Al₆(Mn,Fe) phase. The intermetallic phases hinder recovery and recrystallisation processes and therefore improve the thermal stability of the mechanical properties. Manganese contents of less than 0.3 wt % only result in a very minimal increase in strength by dispersoid and solid solution hardening, so at least 0.3 wt % manganese is provided. From a manganese content of at least 0.4% by weight, a significant increase in strength is achieved by dispersoid and solid solution hardening, which is even more significant from at least 0.6% by weight manganese. Manganese contents of more than 1.5 wt % promote the formation of coarse intermetallic phases, which have an unfavourable effect on the forming properties in the deep drawing process. Furthermore, manganese contents of more than 1.5 wt % reduce the electrical and thermal conductivities of the battery cell housing so greatly that the thermal management becomes inefficient. The Mn content is therefore preferably a maximum of 1.5 wt. %, preferably a maximum of 1.3 wt. %, particularly preferably a maximum of 1.1 wt. %. According to a further embodiment, the Mn/Si ratio is preferably greater than 0.8, since the formation of α-Al(Fe,Mn) Si phase is promoted by this ratio.

According to the invention, the magnesium content of the aluminium alloy is in the range 0.01 wt %≤Mg≤0.60 wt %. In one embodiment of the battery cell housing according to the invention, the magnesium content of the aluminium alloy is in the range 0.05 wt %≤Mg≤0.55 wt %, preferably 0.10 wt %≤Mg≤0.45 wt %. The fact that a magnesium content of up to 0.60 wt % is permitted results in an tolerance of the aluminium alloy for magnesium-containing aluminium alloy scrap such as packaging and UBC scrap, which further promotes the achievement of high proportions of recycled material in the manufacture of the battery cell housings. At the same time, limiting the Mg content to 0.60% by weight allows higher Si contents to be permitted without the aluminium alloy being prone to hot cracking and welding pore formation. In addition, the presence of magnesium from a content of at least 0.01 wt %, preferably at least 0.05 wt %, particularly preferably more than 0.05 wt % or more preferably at least 0.10 wt % leads to a solid solution hardening, which contributes to increased cold hardening and thus a higher strength can be provided. To achieve improved mechanical properties while providing optimal process windows for welding processes, the magnesium content is limited to preferred ranges of 0.05 wt %≤Mg≤0.55 wt %, preferably 0.05 wt %≤Mg≤0.50 wt % or particularly preferably to 0.10 wt %≤Mg≤0.45 wt % and a compromise between high strength, good forming characteristics and high electrical and thermal conductivity with good recycling tolerance and weldability.

According to the invention, the chromium content of the aluminium alloy is in the range Cr≤0.25 wt %. In one embodiment of the battery cell housing according to the invention, the chromium content of the aluminium alloy is in the range Cr≤0.1 wt %, preferably Cr≤0.05 wt %. The fact that a chromium content of up to 0.25 wt % is permitted results in an increased tolerance of the aluminium alloy for chromium-containing aluminium alloy scrap, which promotes the achievement of high proportions of recycled material in the manufacture of the battery cell housings. In addition, chromium also has a strength-increasing effect and forms dispersoids, which increase the thermal stability and hinder softening due to recrystallisation or recovery. However, since excessively high chromium contents may have a detrimental effect on the electrical conductivity of the aluminium alloy, the chromium content is limited according to the invention to at most 0.25 wt %. For improved conductivity with a recycling tolerance and strength that are still sufficient, the chromium content in the aforementioned embodiment is limited to 0.1 wt %, preferably 0.05 wt %.

According to the invention, the zinc content of the aluminium alloy is in the range Zn≤0.5 wt %. In one embodiment of the battery cell housing according to the invention, the zinc content of the aluminium alloy is in the range 0.02 wt %≤Zn≤0.30 wt %, preferably 0.04 wt %≤Zn≤0.25 wt %. The fact that a zinc content of up to 0.5 wt % is permitted results in an increased tolerance of the aluminium alloy for zinc-containing aluminium alloy scrap, which further promotes the achievement of high recycling rates. Zinc also has a strength-increasing effect. However, since excessively high zinc contents reduce the weldability, the electrical and thermal conductivity as well as the corrosion resistance of the aluminium alloy, the zinc content is limited according to the invention to at most 0.5 wt %. In the aforementioned embodiment, the zinc content is adjusted within the corridor 0.02 wt %≤Zn≤0.30 wt %, preferably 0.04 wt %≤Zn≤0.25 wt %, so that an optimal compromise between high strength, good weldability and good electrolyte stability is achieved with a recycling tolerance which remains good.

According to the invention, the titanium content of the aluminium alloy is in the range Ti≤0.2 wt %. In one embodiment of the battery cell housing according to the invention, the titanium content of the aluminium alloy is in the range 0.005 wt %≤Ti≤0.1 wt %, preferably 0.005 wt %≤Ti≤0.05 wt %. The fact that a titanium content of up to 0.2 wt % is permitted results in an increased tolerance of the aluminium alloy for titanium-containing aluminium alloy scrap, which promotes the achievement of high proportions of recycled material in the manufacture of battery cell housings. However, excessively high titanium contents may detrimentally affect the forming properties of the aluminium alloy and significantly reduce the electrical and thermal conductivity, so that the titanium content is limited according to the invention to at most 0.2 wt %. Conversely, titanium above a content of 0.005 wt % improves the grain refinement when casting the aluminium alloy. For good grain refinement together with good formability, sufficiently high electrical and thermal conductivity as well as sufficient recycling tolerance, the titanium content in the aforementioned embodiment is therefore adjusted within the corridor 0.005 wt %≤Ti≤0.1 wt %, preferably 0.005 wt %≤Ti≤0.05 wt %.

In addition to the alloy constituents mentioned above, the remainder of the aluminium alloy of the battery cell housing according to the invention consists of aluminium and unavoidable impurities. Unavoidable impurities are alloy constituents which are not intentionally added but are inevitably contained in the aluminium alloy due to manufacturing. According to the invention, the content of an individual unavoidable impurity is limited to 0.05 wt %, the content of all unavoidable impurities being limited in total to 0.15 wt %. This ensures that the unavoidable impurities have no detrimental effect, or no significant detrimental effects, on the properties of the aluminium alloy, for example by undesired phase formation.

In a further embodiment of the battery cell housing according to the invention, the aluminium alloy has a proportion of at least 50 wt %, preferably at least 70 wt %, particularly preferably at least 85 wt % of recycled material. Due to the high recycling tolerance of the aluminium alloy described above, it is possible to achieve high proportions of recycled contents for the battery cell housing according to the invention without negatively impacting the process parameters for preferred manufacturing methods such as the welding method.

The associated energy saving allows the production of battery cell housings with the smallest possible CO₂ footprint and improved sustainability. The recycled material of the battery cell housing preferably has a proportion of at least 50% by weight, preferably at least 70% by weight, particularly preferably at least 85% by weight of post-consumer scrap. As post-consumer scrap is only generated at the end of the product life cycle, it is considered particularly sustainable and contributes to reducing the CO₂ footprint. Cumulatively or alternatively, the recycled material is made up of at least 50% by weight, preferably at least 70% by weight, particularly preferably at least 85% by weight of pre-consumer scrap or internal and/or external process scrap. With internal process scrap, the compositions and amounts of the individual alloys are generally very well known, so that the alloy composition resulting from the melting of internal process scrap can be determined well. External process scrap is less well defined in its composition than internal process scrap and may require further processing steps, but is generated to a large extent for example in the production of punched parts, so recycling is of high relevance economically and in terms of sustainability. By recycling external process scrap, the need for primary metal can be reduced, which reduces the overall CO₂ balance. Even if the embodiments described later have a maximum proportion of recycled material of 85%, proportions of recycled material of at least 90% can also be achieved with the aluminium alloy composition according to the invention.

In a further embodiment of the battery cell housing according to the invention, the aluminium alloy strip or sheet has a strain-hardened state of the type H1X or a reverse annealed state of the type H2x. In particular, these are the temper states H12, H14, H16, H18 and H19 familiar to the person skilled in the art. Preferably, the aluminium alloy strip or sheet has the strain-hardened state H18 or H19. The aforementioned states, in particular H18 and H19, are characterised by particularly high mechanical stability, so that in particular high strengths may be provided for the battery cell housing. Reverse annealed states of type H2x have improved forming potentials and are often very stable in terms of temperature, making them also very suitable for battery cell housings.

If the aluminium alloy strip or sheet according to a further embodiment of the battery cell housing has a thickness between 0.1 mm and 2.0 mm, the wall thicknesses typical for a battery cell housing can be completely covered. Reducing the thickness to less than 0.1 mm decreases the mechanical stability of the battery cell housing too greatly. Conversely, efficient use of material is no longer possible with a thickness of more than 2.0 mm. In addition, the gravimetric and volumetric energy density of the battery cell or battery module, or battery system, would be reduced too greatly if the aluminium alloy strip or sheet of the battery cell housing were to have a thickness of more than 2.0 mm. The thickness of the aluminium alloy strip or sheet is preferably between 0.25 mm and 1.5 mm, in particular between 0.35 mm and 1.2 mm.

In a further embodiment of the battery cell housing according to the invention, the aluminium alloy strip or sheet has an electrical conductivity σ of at least 40% IACS. Compared to the battery cell housings used to date for cylindrical cells made of nickel-plated steel, the electrical conductivity is therefore increased significantly so faster charging times, lower electrical losses and therefore also less development of heat during operation of the battery cells are achieved. Owing to the Wiedemann-Franz law, according to which there is a direct relationship between the electrical and thermal conductivity of a metal, increased electrical conductivity is furthermore associated with increased thermal conductivity compared to nickel-plated steel. This allows the waste heat generated during operation of the battery cells to be dissipated more efficiently, which among other things improves the quick-charging capability of the battery. Furthermore, the higher thermal conductivity leads to a more homogeneous temperature distribution inside the cell, which has a positive effect on its ageing. The electrical conductivity σ of at least 40% IACS therefore leads overall to an improved performance of the battery cells. Compared to the alloy AA3003, which represents the standard for prismatic battery cell housings and usually has a conductivity between 39.5% IACS and 50% IACS, this electrical conductivity according to the invention is comparable to the extent that no significant changes or even impairments of the thermal or electrical properties of the prismatic battery cell are to be expected due to the use of materials according to the invention with a high content of recycled material.

In a further embodiment, the aluminium alloy strip or sheet has a yield strength R_{p0.2} of at least 125 MPa, preferably at least 150 MPa, in particular at least 180 MPa. As a result, high strengths can be provided for the battery cell housing, which achieve the minimum strength of the standard for prismatic battery boxes AA3003 H14 and preferably significantly exceed it, so the wall thicknesses of the cell housing can at least be maintained, but preferably reduced. For cylindrical battery cell housings with steel as the reference material, the above-mentioned higher yield strengths allow the necessary increase in wall thickness to be moderate and the overall capacity of the battery cell to be only slightly affected by the reduced internal volume. The aluminium alloy strip or sheet preferably has the above-mentioned values for the yield strength before its processing to form the battery cell housing, for example in the state H14, H18 or H24. Yet since the processing of the aluminium alloy strip or sheet, which is typically carried out by cold forming, for example deep drawing, is generally associated with an increase in strength, it may be assumed that the minimum values specified for the yield strength likewise apply to the battery cell housing according to the invention in the finished state. Alternative manufacturing processes for prismatic battery cell housings that are based on local cold forming, such as roll forming, can also be expected to have the same or improved strength compared to the AA3003 alloys used previously.

In a further embodiment of the battery cell housing according to the invention, the aluminium alloy strip or sheet has a wall thickness ratio δ of not more than 2.8, preferably not more than 1.95, with respect to steel before its processing to form the battery cell housing. The wall thickness ratio δ with respect to steel is determined by dividing the yield strength R_{p0.2,St} of a nickel-plated steel strip of type AISI1020 by the yield strength R_{p0.2,A1} of the aluminium alloy strip, a typical value of 350 MPa being set for R_{p0.2,St}. In order to derive the wall thickness ratio δ, the internal pressure loading scenario practically relevant for battery cell housings is considered. For simplification, the battery cell housing is assumed to be a closed and thin-walled cylinder. Based on this, the calculation of the wall thickness ratio δ with respect to steel is carried out by using Barlow's formula, which is known from elastostatics

$${σ}_{φ} = p \cdot {R}_{i} / s \qquad ( 1 )$$

with
σ_{φ}: stress component in the circumferential direction,
p: internal pressure,
Rᵢ: inner radius,
s: wall thicknesses

Using the reference stress according to Tresca

$${σ}_{V , Tresca} = {σ}_{m ax} - {σ}_{m i n} = {σ}_{φ} - 0 = p \cdot {R}_{i} / s \qquad ( 2 )$$

and taking into account a design to prevent a load limited by the start of flow with

$${σ}_{V , Tresca} \leq {R}_{p 0.2} \qquad ( 3 )$$

Follows assuming the same maximum internal pressure

$$p = {R}_{p 0.2 , Al} \cdot {s}_{Al} / {R}_{i , Al} = {R}_{p 0 \text{.2} , St} \cdot {s}_{St} / {R}_{i , St} \qquad ( 4 )$$

with the same inner radii Rᵢ of the cells:

$${R}_{p 0 \text{.2} , Al} \cdot {s}_{Al} = {R}_{p 0.2 , St} \cdot {s}_{St} , \qquad ( 5 )$$

so the wall thickness ratio δ can be calculated from the specified yield strength ratio:

$$δ = {s}_{Al} / {s}_{St} = {R}_{p 0 \text{.2} , St} / {R}_{p 0.2 , Al} . \qquad ( 6 )$$

The wall thickness ratio δ with respect to steel is a measure of the increase in the wall thickness of the battery cell housing when replacing steel with aluminium, and may in particular be used to compare different aluminium alloy strips or sheets with one another. The δ value according to the invention of no more than 2.8, preferably no more than 1.95, continues to have a positive effect on the gravimetric energy density of the battery cells, since the gravimetric energy density can be significantly increased in some cases in combination with the low density of aluminium compared to steel.

The values of the yield strengths Rₚ₀₂ according to the invention lie above, preferably significantly above, the values for the yield strength Rₚ₀₂ of the standard material for prismatic cell housings AA3003 H14, so the usual wall thicknesses can be maintained or reduced. The preferred higher-strength design enables in particular reduced wall thicknesses, in turn enabling an increase in the gravimetric and volumetric energy density of prismatic batteries.

According to a second teaching of the present invention, the aforementioned object is achieved for a use of an aluminium alloy strip or sheet for manufacturing a battery cell housing in that the aluminium alloy strip or sheet is used for manufacturing a battery cell housing according to the first teaching of the invention. Owing to the aforementioned advantageous properties of the aluminium alloy strip or sheet, a battery cell housing which is improved compared to the prior art may therefore be provided.

In one embodiment of the use according to the invention, the battery cell housing is a housing of a secondary cell, preferably a lithium-ion secondary cell or a sodium-ion secondary cell. Since secondary cells, in particular lithium-ion secondary cells, are currently being used increasingly in the fields of electromobility and consumer electronics, the advantageous properties of the aluminium alloy strip or sheet used according to the invention may be used in particular for this type of battery cell. This also applies to sodium-ion secondary cells, which are currently still predominantly the subject of research or have initial industrial uses and might replace lithium-ion secondary cells in future in certain applications owing to better economy and the good availability of sodium. The use of the battery cell housing according to the invention furthermore comprises in particular the use of the housing for solid-state secondary cells that have a solid-state electrolyte.

In a further embodiment of the use according to the invention, the battery cell housing has a cylindrical design, a prismatic design or a pouch design. The advantageous properties of the aluminium alloy strip or sheet used according to the invention may therefore be employed in all currently conventional designs of a battery cell housing.

In a further embodiment of the use according to the invention, the aluminium alloy strip or sheet is manufactured by a method which comprises the following steps:
Casting a rolling ingot from an aluminium alloy,
Homogenising the rolling ingot,
Hot rolling the rolling ingot to form a hot-rolled strip,
Cold rolling of the hot rolled strip with optional intermediate annealing and optional tempering of the cold-rolled strip, preferably reverse annealing of the cold-rolled strip.

The aforementioned process steps are preferably carried out in the order specified, in which case the homogenisation of the rolling ingot may be carried out separately or may be integrated into the preheating of the rolling ingot for the hot rolling. It has been found that with the method described above, it is possible to manufacture an aluminium alloy strip or sheet with which the requirements of a battery cell housing, in particular with regard to strength, electrolyte stability and electrical and thermal conductivity with very good weldability, can be fulfilled when used according to the invention and at the same time high recycling rates can be achieved. Furthermore, this process allows economical manufacture of the aluminium alloy strip or sheet.

The casting of the rolling ingot from an aluminium alloy is preferably carried out in direct-chill continuous casting, also referred to as DC continuous casting, so that the economical viability of the manufacturing process may be further increased.

By homogenising the rolling ingot, an improvement of the microstructure of the aluminium alloy strip or sheet is achieved, which has a positive effect on strength and formability. Preferably, the homogenisation takes place at a temperature of from 480° C. to 620° C., in particular from 550° C. to 610° C., for a duration of at least 0.5 h, preferably at least 1 h, in particular at least 2 h.

The hot rolling of the rolling ingot to form a hot-rolled strip is preferably carried out at a temperature of between 280° C. and 550° C., the hot strip temperature after the last hot rolling pass being between 280° C. and 380° C., preferably between 310° C. and 360° C. The hot rolling of the rolling ingot may take place either reversibly on one roll stand or sequentially in a tandem stand. In particular, the hot rolling may take place reversibly as far as a slab thickness between 20 mm and 50 mm and the slab may then be rolled to hot strip thickness in a tandem stand. The hot strip thickness, i.e. the thickness of the hot-rolled strip, is in one embodiment of the method between 1 mm and 15 mm, preferably between 2 mm and 12 mm, in particular between 2 mm and 9 mm. This ensures that a sufficiently high rolling ratio, by which the strength and formability as well as the crystallographic texture and therefore the ear profile of the aluminium alloy strip or sheet are jointly determined, can be adjusted during the subsequent cold rolling.

The cold rolling of the aluminium alloy strip or sheet may be carried out in one or more passes. In an embodiment of the method in which several cold rolling passes are carried out, at least one intermediate anneal is optionally carried out during the cold rolling. In one embodiment of the method, the intermediate anneal takes place in the temperature range between 150° C. and 450° C., preferably between 200° C. and 400° C., in particular between 300° C. and 400° C. Preferably, the intermediate annealing is carried out as a recrystallisation anneal by which a recrystallised microstructure is provided for the subsequent cold rolling pass. This cold rolling pass may then be carried out with a higher rolling ratio, which has a strength-increasing effect on the finished rolled aluminium alloy strip or sheet. Alternatively, however, recovery annealing may also be carried out instead of recrystallisation annealing, which results in a hardening reduction. All of the temperature specifications mentioned, which characterise annealing processes, always refer to peak metal temperatures (PMT), i.e. the highest temperatures of the metal in the annealing furnace.

In one embodiment of the method, the rolling ratio during the cold rolling at final thickness is at least 20%, preferably at least 50%, in particular at least 70%. If the method is carried out with intermediate annealing during the cold rolling, the rolling ratio in cold rolling at final thickness after the last intermediate anneal is at least 20%, preferably at least 50%, in particular at least 70%. Because of the rolling ratios during the cold rolling at final thickness of at least 20%, preferably at least 50%, in particular at least 70%, the strength of the manufactured aluminium alloy strip or sheet can be increased so that it is particularly suitable for the use according to the invention.

An optional tempering makes it possible to provide an aluminium alloy strip adapted to the manufacturing process of the battery housing, in particular to forming processes, which simultaneously exhibits maximum values for electrical and thus thermal conductivity. This is done by precipitation processes of dissolved alloy components during tempering. Battery cell housings are preferably manufactured from aluminium alloy strips in hard-rolled states H1x or state-annealed states H2x. However, soft-annealed variants are at least conceivable for very low requirements in terms of the strength of the battery cell housing in combination with a high-strength material.

### BRIEF DESCRIPTION OF THE DRAWINGS

The invention will be explained in more detail below with the aid of exemplary embodiments, reference also being made to the drawing. In the drawing,

FIG. 1 shows a schematic representation of a battery cell of cylindrical design with a battery cell housing according to the invention,

FIG. 2 shows a schematic representation of a battery cell of prismatic design with a battery cell housing according to the invention,

FIG. 3 shows a schematic representation of a battery cell in pouch design with a battery cell housing according to the invention, and

FIG. 4 shows a flowchart of a method for manufacturing an aluminium alloy strip or sheet for the use according to the invention.

### DETAILED DESCRIPTION

FIG. 1 shows an embodiment of a battery cell 10 of cylindrical design in a schematic representation. The battery cell 10 has a battery cell housing 11 according to the invention and, adjacent thereto, an anode terminal 12 and a cathode terminal 13.

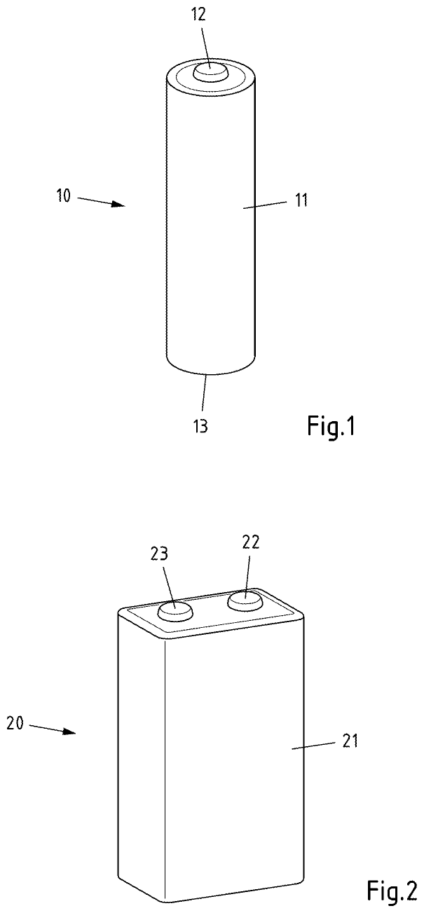

FIG. 2 shows an embodiment of a battery cell 20 of prismatic design in a schematic representation. The battery cell 20 has a battery cell housing 21 according to the invention and, adjacent thereto, an anode terminal 22 and a cathode terminal 23.

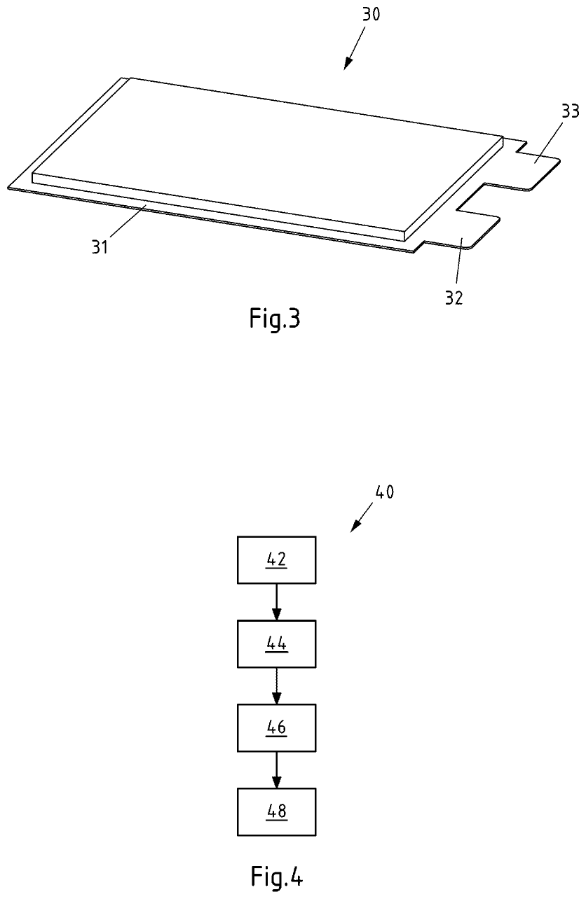

FIG. 3 shows a battery cell 30 in a pouch design in a schematic representation. The battery cell 30 has a battery cell housing 31 according to the invention and, adjacent thereto, an anode terminal 32 and a cathode terminal 33.

FIG. 4 shows a flowchart of an embodiment of a method 40 for manufacturing an aluminium alloy strip or sheet for the use according to the invention. The method 40 comprises the following steps:
Casting (42) a rolling ingot from an aluminium alloy,
Homogenising (44) the rolling ingot,
Hot rolling (46) rolling the rolling ingot to form a hot-rolled strip,
Cold rolling (48) the hot rolled strip with optional intermediate annealing and optional final annealing (both not shown).

After cold rolling, the strips are in the temper states H12, H14, H16, H18 or H19 depending on the degree of cold rolling of the hot strip thickness or intermediate annealing thickness. However, the cold rolling can optionally be followed by a heat treatment of the strip (not shown) in the form of a tempering, preferably in the form of a reverse annealing. After reverse annealing, the yield strength values R_{p0.2} are barely reduced. However, the possible degrees of deformation and conductivities are improved in the H24 state, for example. This is shown by the following embodiments. However, it is also conceivable to manufacture the aluminium strips using manufacturing processes that comprise continuous casting of the aluminium strip. In this case, steps 42, 44 and 46 are omitted and the casting belt manufactured is cold rolled.

A total of 10 different aluminium alloy strips were produced, with the chemical composition of the aluminium alloys having 2 to 9 recycled contents of more than 50%. The respective alloy compositions of strips 1 to 10 are indicated in Table 1 below. The contents of the individual alloy elements are all specified in wt %. The remainder, i.e. the difference from 100 wt %, consists of aluminium and unavoidable impurities, individually at most 0.05 wt % and in total at most 0.15 wt %.

Strips 2 to 8 represent aluminium alloy strips according to the invention, which allow very high proportions of recycled material. As an example, lines 2, 3 and 4 were manufactured with 77%, 74% and 86% recycled content, whereby the recycled content includes both internal scrap, so-called pre-consumer scrap, and external scrap. Aluminium alloy strip 9 was manufactured with 90% recycled content, but has too high a magnesium content. On the other hand, comparative example 10, which has a magnesium-free composition, requires a primary aluminium-based manufacturing of the aluminium alloy with no recycled content.

The aluminium alloy strips 1 to 10 were manufactured with the method shown in FIG. 4. The different tempering states are indicated in Table 2. Specifically, rolling ingots were cast from the respective aluminium alloys using the DC continuous casting method. A proportion of at least 70 wt % recycled material was selected for manufacturing the rolling ingots of strips 2 to 8 according to the invention. Comparative example 10 was cast from primary aluminium based on sows and pre-alloys.

TABLE 1

| No. | | Si | Fe | Cu | Mn | Mg | Cr | Zn | Ti |
|---|---|---|---|---|---|---|---|---|---|
| 1 | Comp. | 0.47 | 0.47 | 0.16 | 1.10 | 0.48 | <0.01 | <0.01 | 0.02 |
| 2 | Inv. | 0.51 | 0.45 | 0.16 | 1.06 | 0.51 | <0.01 | 0.02 | 0.02 |
| 3 | Inv. | 0.42 | 0.47 | 0.13 | 1.07 | 0.59 | <0.01 | 0.01 | 0.01 |
| 4 | Inv. | 0.45 | 0.51 | 0.15 | 1.06 | 0.46 | 0.01 | 0.01 | 0.02 |
| 5 | Inv. | 0.52 | 0.53 | 0.21 | 1.17 | 0.43 | 0.03 | 0.25 | 0.02 |
| 6 | Inv. | 0.52 | 0.53 | 0.21 | 1.17 | 0.43 | 0.03 | 0.25 | 0.02 |
| 7 | Inv. | 0.52 | 0.53 | 0.21 | 1.17 | 0.43 | 0.03 | 0.25 | 0.02 |
| 8 | Inv. | 0.52 | 0.53 | 0.21 | 1.17 | 0.43 | 0.03 | 0.25 | 0.02 |
| 9 | Comp. | 0.25 | 0.59 | 0.18 | 0.84 | 1.03 | 0.01 | 0.04 | 0.02 |
| 10 | Comp. | 0.20 | 0.53 | 0.14 | 1.05 | <0.01 | <0.01 | <0.01 | 0.02 |

The rolling ingots were homogenised after casting and then hot-rolled to form strips. The hot-rolled strips were then each cold-rolled to a final thickness of between 0.47 mm and 1.5 mm. Strips 2, 3, 4, 6 and 8 according to the invention as well as comparative example 10 are available in the hard-rolled states H14 and H18 after cold rolling. Intermediate annealing was carried out by coil annealing at 320° C. PMT. Embodiment 1 was softened after cold rolling to state O. Coil annealing was also carried out. The holding time of the coil annealing after the heating phase was at least 3 h for all coil annealing at the specified PMT.

Embodiments 5 and 7 as well as the comparative example 9 were brought into the state H24 by means of reverse annealing. For laboratory annealing, sheet sections were annealed for 3 hours with a PMT of 240° C. in a laboratory furnace, for example. Finally, the aluminium alloy strips 6, 7 and 8 were manufactured from an identical alloy with different end thicknesses and tempering states, here H18 and H24. As expected, the tempering states determine the values for the yield strength R_{p0.2} almost independently of the final thickness.

The following Table 2 shows various method parameters for the manufacture of strips 1 to 10. Specifically, these are the hot strip thickness, i.e. the respective thickness of the hot rolled strip, the temperature of the intermediate and final annealing as PMT, the degree of cold rolling starting from the hot strip if no intermediate annealing was provided or starting from the thickness of the aluminium strip after the intermediate annealing up to the final thickness of the aluminium strip. The proportion of recycled metal is also indicated in Table 2. This proportion arises from the mass of the sum of the internal scrap used, i.e. scrap from the manufacture of aluminium strips or sheets and the external scrap used, which consists of post-consumer and further processing scrap, in relation to the mass of primary metal used in the manufacture of the respective embodiment.

TABLE 2

| | | | | Inter- | Degree of | Final | Proportion |
|---|---|---|---|---|---|---|---|
| | | | Hot strip | mediate | cold | annealing | of |
| | Thickness | Tempering | thickness | anneal | rolling | PMT | recycled |
| No. | [mm] | State | [mm] | PMT [° C.] | [%] | [° C.] | metal |
| 1 | 0.5 | O | 5.5 | — | 91 | Coil | 34% |
| | | | | | | annealing | |
| | | | | | | 400° C. | |
| 2 | 0.48 | H14 | 6.5 | Coil | 30 | | 77% |
| | | | | annealing | | | |
| | | | | 320° C. | | | |
| 3 | 0.48 | H14 | 6.5 | Coil | 30 | | 74% |
| | | | | annealing | | | |
| | | | | 320° C. | | | |
| 4 | 0.98 | H14 | 6.5 | Coil | 30 | | 86% |
| | | | | annealing | | | |
| | | | | 320° C. | | | |
| 5 | 0.47 | H24 | 3.5 | — | 87 | Laboratory | 85% |
| | | | | | | annealing | |
| | | | | | | 3 h at | |
| | | | | | | 240° C. | |
| 6 | 0.47 | H18 | 3.5 | — | 87 | | 85% |
| 7 | 0.7 | H24 | 3.5 | — | 80 | Laboratory | 85% |
| | | | | | | annealing | |
| | | | | | | 3 h at | |
| | | | | | | 240° C. | |
| 8 | 0.7 | H18 | 3.5 | — | 80 | | 85% |
| 9 | 0.95 | H24 | 2.3 | — | 59 | Laboratory | 90% |
| | | | | | | annealing | |
| | | | | | | 3 h at | |
| | | | | | | 240° C. | |
| 10 | 1.0 | H14 | 7.0 | Coil | 28 | | 0% |
| | | | | annealing | | | |
| | | | | 400° C. | | | |

As can be seen from Table 2, strip No. 1 (comparative example) was manufactured without intermediate annealing and brought to state O by a final soft annealing. Strips 2 to 4 according to the invention and the comparative example strip No. 10 were manufactured with intermediate annealing of the respective coils in a corresponding coil furnace. Strips 5 to 9 were rolled to final thickness like strip No. 1 with no intermediate annealing, wherein strips 5, 7 and 9 were brought to the semi-hard state H24 by a final annealing, while strips 6 and 8 were not annealed and were examined in the hard-rolled state H18. As already stated, the specified annealing temperatures (PMT) of the metal were maintained for at least 3 h for all coil annealing.

The aluminium alloy strips were subsequently examined for various properties relevant to battery cell housings. The results of these tests are summarised in Table 3. The focus was on the yield strength R_{p0.2}, the electrical conductivity in % IACS and the weldability.

All aluminium alloy strips according to the invention showed sufficiently large (+) process windows in terms of weldability, which enable the reliable sealing welding of battery cell housings. Comparative example 10 enables an even larger process window (++) due to the strictly limited chemical composition. However, due to the strongly restricted chemical composition, the use of scrap, in particular external scrap, preferably external post-consumer scrap, is very strongly restricted compared to the strips according to the invention. Comparative example 9 with a significantly higher Mg content showed a narrower process window in the welding tests due to an increased tendency to hot crack as well as a higher tendency to form pores with a negative impact on the impermeability, which entails the risk of a higher reject rate.

The values for the yield strength R_{p0.2} were determined in the tensile test according to DIN EN ISO 6892-1 and showed values of at least 183 MPa in the embodiments according to the invention. The wall thickness ratio δ with respect to steel was determined by dividing the yield strength R_{p0.2,St} of 350 MPa, which is a typical value for a nickel-plated steel strip of type AISI1020, by the yield strength R_{p0.2,Al} of the respective aluminium alloy strip.

TABLE 3

| | | | | | Wall | Electric. | |
|---|---|---|---|---|---|---|---|
| | | Thickness | Tempering | R_{p0.2} | thickness | conductivity | |
| No. | | [mm] | State | [MPa] | ratio δ | [% IACS] | Weldability |
| 1 | Comp. | 0.5 | O | 55 | 6.36 | 50.0 | + |
| 2 | Inv. | 0.48 | H14 | 184 | 1.90 | 50.0 | + |
| 3 | Inv. | 0.48 | H14 | 200 | 1.75 | 48.3 | + |
| 4 | Inv. | 0.98 | H14 | 183 | 1.91 | 50.0 | + |
| 5 | Inv. | 0.47 | H24 | 206 | 1.70 | 45.0 | + |
| 6 | Inv. | 0.47 | H18 | 283 | 1.24 | 44.6 | + |
| 7 | Inv. | 0.7 | H24 | 201 | 1.74 | 45.3 | + |
| 8 | Inv. | 0.7 | H18 | 266 | 1.32 | 44 | + |
| 9 | Comp. | 0.95 | H24 | 190 | 1.84 | 41.7 | o |
| 10 | Comp. | 1.0 | H14 | 157 | 2.23 | 49.1 | ++ |

The embodiments according to the invention with cold-hardened state H1X, in particular in state H18, allow the use of wall thickness ratios that lie in the range of 1.24 to 1.32. A high gravimetric energy density of the battery cells can therefore be expected. Slightly reduced gravimetric energy densities can be expected due to the lower yield strength R_{p0.2} with reverse annealed variants in the H24 state. However, these in turn result in significant advantages in electrical conductivity and thus also in thermal conductivity of almost 3%.

For use in prismatic battery cells, whose battery cell housings are usually manufactured from the alloy AA3003 in the state H14, yield strengths Rₚ₀₂ of more than 125 MPa are already sufficient to maintain or reduce the wall thickness of common cell formats, for example, at yield strengths.

Throughout, the electrical conductivities in % IACS of the embodiments according to the invention are between about 5.5% and a maximum of about 25% higher than in comparative example 9 with a similarly high proportion of recycled material, so the heat management of the battery cell housings made of aluminium alloy strips according to the invention is likely to be significantly improved compared to this comparative example.

With electrical conductivities σ of at least 44% IACS and more, the electrical conductivity compared to the battery cell housings of round cells used previously and made of nickel-plated steel is significantly increased, so faster charging times, lower electrical losses and thus also lower heat development can be achieved during operation of the battery cells.

The electrical conductivities of the strips according to the invention are also comparable to the standard material for prismatic battery cell housings AA3003 H14, which is represented by comparative example 10. Owing to the Wiedemann-Franz law, according to which there is a direct relationship between electrical and thermal conductivity in metals, similar considerations also apply for the thermal conductivity. An improved thermal conductivity of the aluminium alloy strips according to the invention compared to nickel-plated steel enables significantly more efficient cooling of the battery cells, in particular at the high C-rates that occur during rapid charging. At the same time, a more homogeneous temperature distribution is expected due to the improved thermal conductivity over the coil, which improves the ageing properties of the battery cell.

As Table 3 further shows, the strips according to the invention have a thickness between 0.1 mm and 2.0 mm. A good compromise between mechanical stability and efficient use of materials is therefore achieved during use for manufacturing a battery cell housing according to the invention.

The battery cells (10, 20, 30) shown in FIGS. 1 to 3 may be secondary cells, in particular lithium-ion secondary cells or sodium-ion secondary cells, so that the battery cell housings (11, 21, 31) according to the invention are respectively housings of a secondary cell, in particular a lithium-ion secondary cell or a sodium-ion secondary cell. The advantageous properties of the aluminium alloy strips used according to the invention may therefore be employed in particular for these types of battery cells.

Furthermore, the battery cell housings (11, 21, 31) according to the invention shown in FIGS. 1 to 3 may in particular have a cylindrical design, a prismatic design or a pouch design. FIG. 1 shows a battery cell housing (11) according to the invention in cylindrical design; FIG. 2 shows a battery cell housing (21) according to the invention in prismatic design, and FIG. 3 shows a battery cell housing (31) according to the invention in pouch design. The advantageous properties of the aluminium alloy strips used according to the invention may therefore be used in all currently typical designs of a battery cell housing.

Furthermore, the aluminium alloys on which the battery cell housings (11, 21, 31) according to the invention, shown in FIGS. 1 to 3, are based preferably have a proportion of at least 50 wt %, preferably at least 70 wt %, or particularly preferably at least 85 wt % of recycled material. The recycling rate is preferably achieved by using post-consumer scrap. The associated energy saving allows the production of battery cell housings with the smallest possible CO₂ footprint and increases the sustainability of the battery cell housings. The high recyclability in turn is attributable to the battery cell housing (11, 21, 31) according to the invention due to its alloy composition, which allows high proportions of recycled material, preferably of post-consumer scrap. In addition or alternatively, the recycling rate may also be achieved by using internal or external process scrap and also a reduction of the CO₂ footprint may likewise be achieved compared to a primary aluminium-based production.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Battery cell housing having an aluminium alloy strip or sheet,
wherein the aluminium alloy strip or sheet has an aluminium alloy with the following alloy constituents in wt %: 0.1%≤Si≤0.7%, 0.2%≤Fe≤0.8%, Cu≤0.6%, 0.3%≤Mn≤1.5%, 0.01%≤Mn≤0.60%, preferably 0.05%≤Mn≤0.55%,
$$Cr \leq 0.25 \% , \\ Zn \leq 0.5 \% , \\ Ti \leq 0.2 \% ,$$
the remainder being Al and unavoidable impurities, individually at most 0.05% and in total at most 0.15%.

2. Battery cell housing according to claim 1,
wherein the aluminium alloy strip or sheet has an aluminium alloy with the following alloy constituents in wt %: 0.2%≤Si≤0.55%, preferably 0.35%≤Si≤0.55%, 0.2%≤Fe≤0.65%, preferably 0.25%≤Fe≤0.55%, Cu≤0.3%, preferably 0.1%≤Cu≤0.2%, 0.3%≤Mg≤1.3%, preferably 0.4%≤Mg≤1.1%, 0.05%≤Mg≤0.50%, preferably 0.10%≤Mg≤0.45%, Cr≤0.1%, preferably Cr≤0.05%, 0.02%≤Zn≤0.30%, preferably 0.04%≤Zn≤0.25%, 0.005%≤Ti≤0.1%, preferably 0.005%≤Ti≤0.05%, the remainder being Al and unavoidable impurities, individually at most 0.05% and in total at most 0.15%.

3. Battery cell housing according to claim 1,
wherein the aluminium alloy has a proportion of at least 50 wt %, preferably at least 70 wt %, particularly preferably at least 85% of recycled material.

4. Battery cell housing according to claim 1,
wherein the aluminium alloy strip or sheet has a cold-hardened state of the type H1X, preferably the cold-hardened state H18 or H19 or a reverse annealed state H2x, preferably H24.

5. Battery cell housing according to claim 1,
wherein the aluminium alloy strip or sheet has a thickness between 0.1 mm and 2.0 mm, preferably between 0.25 mm and 1.5 mm, particularly preferably between 0.35 mm and 1.2 mm.

6. Battery cell housing according to claim 1,
wherein the aluminium alloy strip or sheet has an electrical conductivity σ of at least 40% IACS.

7. Battery cell housing according to claim 1,
wherein the aluminium alloy strip or sheet, preferably prior to its processing to become the battery cell housing, has a yield strength R_{p0.2} of at least 125 MPa, preferably at least 150 MPa, particularly preferably at least 180 MPa.

8. Use of an aluminium alloy strip or sheet for manufacturing a battery cell housing according to claim 1.

9. Use according to claim 8,
wherein the battery cell housing is a housing of a secondary cell, preferably a lithium-ion secondary cell, a sodium-ion secondary cell or a solid-state secondary cell.

10. Use according to claim 8,
wherein the battery cell housing has a cylindrical design, a prismatic design or a pouch design.

11. Use according to claim 8,
wherein the aluminium alloy strip or sheet is manufactured by a method which comprises the following steps:
Casting a rolling ingot from an aluminium alloy,
Homogenising the rolling ingot,
Hot rolling the rolling ingot to form a hot-rolled strip,
Cold rolling the hot-rolled strip and
optional tempering of the cold-rolled strip, preferably reverse annealing of the cold-rolled strip.

12. Use according to claim 11,
wherein the thickness of the hot-rolled strip is between 1 mm and 15 mm, preferably between 2 mm and 12 mm, particularly preferably between 2 mm and 9 mm.

13. Use according to claim 11,
wherein at least one intermediate anneal takes place during the cold rolling.

14. Use according to claim 11,
wherein the rolling ratio during the cold rolling at final thickness, preferably the rolling ratio after the last intermediate anneal, is at least 20%, preferably at least 50%, particularly preferably at least 70%.
